(19) United States
(12) Patent Application Publication
(10) Pub. No.: US 2013/0009101 A1
(43) Pub. Date: Jan. 10, 2013

(54) GAS DEACIDIZING METHOD USING AN ABSORBENT SOLUTION WITH COS REMOVAL THROUGH HYDROLYSIS

(76) Inventor: Jérémy Gazarian, Condrieu (FR)

(21) Appl. No.: 13/497,295

(22) PCT Filed: Sep. 15, 2010
(86) PCT No.: PCT/FR2010/000621

§ 371 Date: Sep. 27, 2012

(30) Foreign Application Priority Data
Sep. 21, 2009 (FR) 0904496

(51) Int. Cl. B01D 53/48; C01B 3/54; C10L 3/10; B01D 53/52

(52) U.S. Cl. 252/373; 423/244.09; 423/244.1; 423/228

(57) ABSTRACT

The method deacidifies a gas including H₂S and CO₂. The gas is subjected to an absorption to collect the CO₂ and the H₂S in an absorber, then to conversion through hydrolysis of the COS to H₂S and CO₂ in a reactor, and to a second absorption to collect the H₂S and the CO₂ formed in the reactor. The absorbent solution is regenerated in regenerator. The regenerated absorbent solution is separated into two which are:
a main stream supplying the absorber, and
a remaining stream supplying the second absorption

### BACKGROUND OF THE INVENTION

1. Field of the Invention

The present invention relates to deacidification methods of using an absorbent solution.

Absorption methods using an aqueous amine solution are commonly used to remove carbon dioxide (CO₂) and hydrogen sulfide (H₂S) from a gas. The gas is purified by contact with the absorbent solution and then the absorbent solution is thermally regenerated.

Carbonyl sulfide (COS) can be present in a natural gas, as well as in a synthesis gas. Conventional chemical solvents do not allow the COS to be efficiently removed. In any case, conventional chemical solvents do not allow the H₂S and the COS to be selectively removed in relation to CO₂.

In the case of natural gas treatment, a significant presence of COS in the feed gas is often problematic and a stringent total sulfur specification in the treated gas is constrained by the COS content in the feed gas.

In the case of a synthesis gas, and according to the downstream applications of the gas, COS is often considered to be a pollutant and the treated gas must have very low COS contents, down to less than 1 ppm.

2. Description of the Prior Art

WO-96/19,281 describes treatment of an acidic natural gas by carrying out catalytic hydrolysis of COS between two absorption stages. The catalytic hydrolysis reactor is arranged outside the absorption column. The gas phase hydrolysis reaction is as follows:

COS+H₂O [symbol] H₂S+CO₂

The reaction is thus promoted for low H₂S and CO₂ partial pressures. WO-96/19,281 thus describes reduction of the H₂S partial pressure before COS hydrolysis by carrying out an absorption stage in the lower section of the absorption column. Then the acid gases are removed at the hydrolysis reactor outlet through absorption in the upper section of the absorption column.

### SUMMARY OF THE INVENTION

The present invention improves the method described in WO-96/19,281 by optimizing the distribution of the absorbent solution streams in the absorption section.

In general terms, the present invention provides a method of deacidifying a gas comprising H₂S and COS, by the following stages:

(a) contacting the gas with a first absorbent solution stream in a first absorption section to obtain an H₂S-depleted gaseous effluent and an H₂S-laden absorbent solution;

(b) feeding the H₂S-depleted gaseous effluent into a reactor that performs a reaction of hydrolysis of the COS into H₂S and CO₂ to obtain a COS-depleted gaseous effluent;

(c) contacting the COS-depleted gaseous effluent with a second absorbent solution stream in a second absorption section to obtain a treated gas and an absorbent solution partly laden with H₂S; and

(d) regenerating the H₂S-laden absorbent solution to obtain a regenerated absorbent solution stream.

According to the invention, in stage (a), the first absorbent solution stream comprises a first portion of the regenerated absorbent solution obtained in stage (d), as well as the absorbent solution partly laden with H₂S, and in stage (c) the second absorbent solution stream comprises a second portion of the regenerated absorbent solution stream obtained in stage (d).

According to the invention, the first portion can comprise at least 70 vol. % of the regenerated absorbent solution stream obtained in stage (d) and the second portion can comprise less than 30 vol. % of the regenerated absorbent solution stream obtained in stage (d).

The pressure in the first absorption section can be at least 2 bars above the pressure in the second absorption section and, in this case, the pressure can be raised by pumping the absorbent solution partly laden with H₂S prior to feeding it into the first absorption section.

The reactor can, for example, comprise a COS hydrolysis reaction catalyst, a titanium oxide or an alumina oxide.

The regenerated absorbent solution stream can comprise at least one amine in aqueous phase.

In stage (d), the H₂S-laden absorbent solution can be subjected to at least one distillation. In stage (d), the H₂S-laden absorbent solution can also be subjected to expansion.

The gas can be selected from among a natural gas, and a synthesis gas, a combustion fume.

Applying a limited absorbent solution flow rate in stage (c) allows significant reduction of the diameter of the second absorption section while keeping the COS specifications. This involves a significant decrease in the cost of the absorber and a decrease in the operating cost of the method.

### BRIEF DESCRIPTION OF THE DRAWING

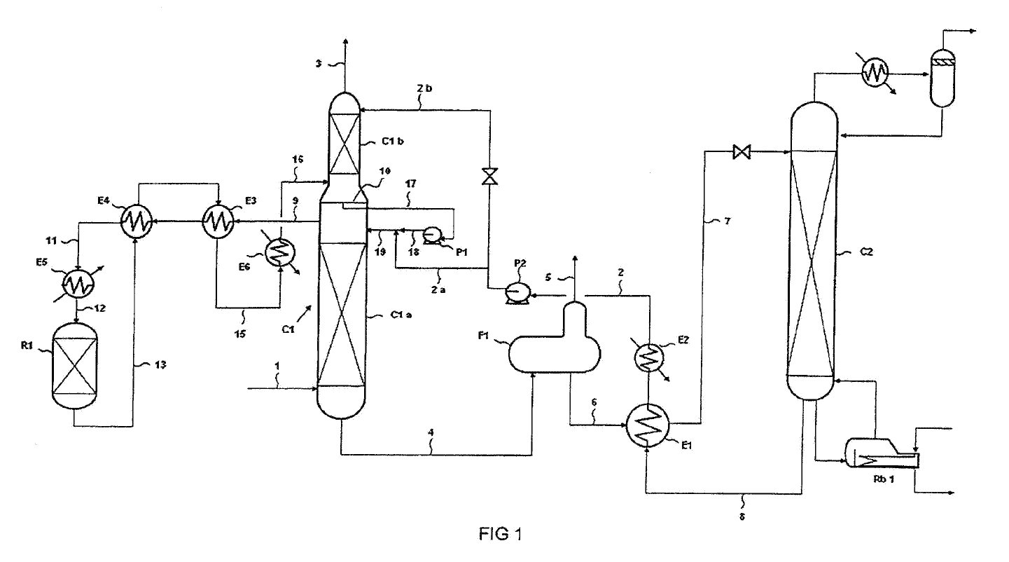

Other features and advantages of the invention will be clear from reading the description hereafter, with reference to FIG. 1 that diagrammatically shows an embodiment example of the method according to the invention.

### DETAILED DESCRIPTION

With reference to FIG. 1, the gas to be treated flows in through line 1 at a pressure that can range between 1 and 150 bars, and at a temperature that can range between 10° C. and 70° C. The gas can be, for example, a natural gas, a synthesis gas, a gas produced by coal gasification, or fumes from a combustion process. The gas comprises acidic compounds to be removed, which notably are H₂S and COS, and possibly CO₂. In the case of natural gas, the gas circulating in line 1 can be at a pressure ranging between 20 and 100 bars.

The gas to be treated flowing in through line 1 is contacted in absorption section C1a with an absorbent solution flowing in through line 19. Section C1a is an enclosure provided with gas-liquid contacting elements, for example trays, a random packing or a stacked packing.

The composition of the absorbent solution is selected for its capacity to absorb the acidic compounds.

An absorbent solution comprising a chemical solvent can be used, for example a solution comprising in general between 10 wt. % and 80 wt. %, preferably between 20 wt. % and 60 wt. % amines, preferably alkanolamines, and comprising at least 20 wt. % water, the sum of the compounds being 100%. The following amines can be used: MEA (monoethanolamine), DEA (diethanolamine), MDEA (methyldiethanolamine), DIPA (diisopropylamine), DGA (diglycolamine), diamines, piperazine, hydroxyethyl piperazine. An amine type or a mixture of several amines can be used, for example a mixture of one or more tertiary amines with one or more primary or secondary amines.

Alternatively, an absorbent solution comprising a physical solvent can be used, for example methanol, N-formyl morpholine, glycol ethers, sulfolane, thiodiethanol. The physical solvent can be mixed with an aforementioned chemical solvent and/or with water.

If it is desired to selectively absorb the H₂S in relation to CO₂, an absorbent solution comprising a solvent with thermodynamic and kinetic properties that confer a selective character on the absorbent solution can be used. It is possible to use an amine whose intrinsic characteristics are a rate of reaction with H₂S that is at least twice, or even three times as high as its rate of reaction with CO₂. For example, the absorbent solution comprises a tertiary amine, MDEA for example, or an amine comprising a sterically hindered amine function, DIPA for example. The selective absorbent solution can comprise between 10 wt. % and 80 wt. %, preferably between 20 wt. % and 60 wt. % amines, and at least 20 wt. % water with the sum of the compounds being 100%. It is also possible, for example, to use a selective physical solvent in aqueous solution, such as dimethyl ether polyethylene glycol or N-methylpyrrolidone.

In the case of natural gas treatment, section C1a can operate at a temperature ranging between 20° C. and 100° C., and at a pressure ranging between 20 bars and 100 bars. In section C1a, the solution flowing in through line 19 absorbs the acidic compounds contained in the gas which are notably H₂S and CO₂. However, considering the low affinity of amines for COS, the COS remains predominantly present in the gas. The H₂S-depleted gas is discharged from section C1a through line 9. The gas discharged through line 9 is water-saturated because the absorbent solution contains water. The absorbent solution laden with acidic compounds is discharged in the bottom of C1a through line 4 and sent to one or more regeneration stages.

The gas circulating in line 9 is heated in heat exchangers E3 and E4. Exchangers E3 and E4 allow recovery of the heat contained in the hot gas from reactor R1 in order to thermally best optimize the method according to the invention. The heated gas coming from E4 through line 11 can be sent, in some cases, to an additional heat exchanger E5 allowing reaching temperature levels required for the hydrolysis stage carried out in R1.

The hot gas leaving E5 through line 12 is fed into catalytic reactor R1. For example, R1 is a fixed bed reactor whose catalyst can be a titanium oxide, an alumina oxide or a zirconium oxide. The catalyst comes in solid form, such as, for example, extrudates. Preferably, a catalyst CRS31 is used which is marketed by the Axens Company. Under the effect of the catalyst, the COS contained in the water-saturated gas is converted to H₂S and CO₂ according to the hydrolysis reaction as follows: COS+H₂O [symbol] H₂S+CO₂. In general, reactor R1 can operate at a pressure ranging between 20 and 100 bars, and at a temperature at least above 100° C.

The gas discharged from reactor R1 through line 13 is significantly depleted in COS, and contains CO₂ and H₂S produced by hydrolysis of the COS. The gas is cooled in exchangers E4, then E3, by heat exchange with the gas coming from C1a through line 9. The gas leaving E4 through line 15 can be cooled in an additional heat exchanger E6 so as to reach the thermal level required in the absorption section.

The cooled gas leaving E6 through line 16 is fed into absorption section C1b in order to be contacted with the absorbent solution flowing in through line 2b. Section C1a is an enclosure provided with gas-liquid contacting elements, for example trays, a random packing or a stacked packing. In section C1b, solution 2b absorbs the acidic compounds contained in the gas, notably the H₂S and the CO₂ produced by hydrolysis of the COS in reactor R1. The treated gas is discharged from section C1b through line 3. The absorbent solution laden with acidic compounds is discharged in the bottom of C1b through line 17 and then is fed into the top of absorption section C1a via pump P1 and lines 18 and 19.

Sections C1a and C1b are distinct from one another. C1a and C1b can be arranged in two different columns. Alternatively, sections C1a and C1b can be arranged in a single column C1 as shown in FIG. 1. A sealed tray 10 separates section C1a from section C1b.

The absorbent solution discharged in the bottom of section C1a through line 4 is subjected to one or more regeneration stages. According to FIG. 1, the absorbent solution is expanded and then is fed into a flash drum F1 at a pressure ranging for example between 5 and 15 bars. The vapor fraction released through expansion is discharged at the top of drum F1 through line 5. The liquid discharged in the bottom of F1 is heated in exchanger E1 by heat exchange with the regenerated absorbent solution flowing in through line 8. The hot absorbent solution leaving E1 through line 7 is fed into thermal regeneration column C2 equipped, for example, with gas-liquid separation internals, trays, random packings or stacked packings. A portion of the absorbent solution is withdrawn at the bottom of C2, heated by reboiler Rb1, for example to a temperature ranging between 80° C. and 150° C. and then is fed again into the bottom of C2. The acidic compounds, notably H₂S and CO₂, are released in gas form at the top of C2. The regenerated absorbent solution is discharged in the bottom of C2 through line 8 cooled in heat exchangers E1 and then E2 so as to reach a temperature preferably ranging between 25° C. and 50° C.

According to the invention, at the outlet of exchanger E2, the stream circulating in line 2 is pumped by pump P2, then divided into two portions which are a main portion circulating in 2a and the remaining portion circulating in 2b. The main portion circulating in 2a comprises at least 70% and preferably at least 80% or even 90% of the volume flow rate of the stream circulating in line 2. This main portion is mixed with the absorbent solution stream coming from the bottom of section C1b through line 18. The mixture that is obtained is injected through line 19 to the top of section C1a, such as, for example, at a level located in the upper half of section C1a. The remaining portion of regenerated absorbent solution 2 is fed to the top of section C1b through line 2b. The portion circulating in line 2b comprises less than 30% and preferably less than 20% or even less than 10% of the volume flow rate of the stream circulating in line 2.

The main portion of the regenerated absorbent solution 2a (for example, 80% to 90% of the total flow rate of solution 8) allows collection of a large part of the acidic compounds in C1a. Thus, the acidic compound partial pressure in the gas is decreased which promotes hydrolysis of the COS in R1. A limited stream (for example of 10% to 20% of the remaining flow rate of solution 8) is sent to the top of absorption section C1b. This limited stream is sufficient to absorb the small amount of acidic compounds formed upon COS hydrolysis in R1. Furthermore, sending an absorbent solution flow rate to C1b that is lower than the absorbent solution flow rate sent to C1a, allows reduction of the dimension of section C1b in relation to the dimension of section C1a. For example, the diameter of section C1b can be reduced. The method according to the invention allows implementation of a section C1b whose diameter can be at least 30%, preferably at least 50% less than the diameter of section C1a. Moreover, since section C1b operates at a pressure slightly lower than the pressure in section C1a (approximately 2 to 5 bars less), it is necessary to compress the absorbent solution 17 obtained in the bottom of section C1b with P1 to the operating pressure of section C1a prior to recycling it to C1a. Having a limited absorbent solution flow rate circulating in C1a allows reduction of the cost of the compression operation in P1. Moreover, a relatively low absorbent solution flow rate is sent to section C1b in order to absorb a sufficient amount of H₂S while limiting CO₂ absorption.

The method operation example according to FIG. 1, presented hereafter, highlights the advantages of the method according to the invention.

The method according to FIG. 1 is implemented in order to remove the COS contained in a natural gas to reach a specification on the treated gas of 1 ppmv COS. The method illustrated in FIG. 1 can reduce the total sulfur content of a gaseous feed stream 1. Table 1 gives the compositions and the operating conditions of the incoming/outgoing streams of the COS hydrolysis reactor, obtained from a numerical modelling specific to this reactor.

TABLE 1

Stream number
Description

| | 12 | 13 |
|---|---|---|
| | R1 inlet | R1 outlet |
| Temp. (° C.) | 140 | 140.05 |
| Pressure (Bar) | 75.5 | 74.0 |
| Molar flow rate | 2717.7 | 2717.7 |
| (kmol/h) | | |
| Mass flow rate | 58783.8 | 58783.8 |
| (kg/h) | | |
| Comp. (% mol) | | |
| CO2 | 2.027 | 2.0353 |
| H2S | 0.0002 | 0.0083 |
| COS | 0.0081 | 0.0001 |
| H2O | 0.1738 | 0.1658 |
| N2 | 0.268 | 0.268 |
| C1 | 89.188 | 89.188 |
| C2 | 4.892 | 4.892 |
| C3+ | 3.443 | 3.443 |

Table 1 shows that the gas at the reactor outlet allows the COS specification to be reached while limiting the pressure drop.

Table 2 gives all the stream compositions and operating conditions obtained by means of a numerical process simulation software specific to gas-liquid absorption columns. This example shows that a certain selectivity can be kept for the treated gas while removing the COS present in the natural gas. Furthermore, this example shows that a low flow rate of absorbent solution 2b in C1b is sufficient to reach a severe sulfur content specification (i.e. less than 4 ppm sulfur), while limiting CO₂ absorption.

TABLE 2

| | Stream number | | | |
|---|---|---|---|---|
| | Description | | | |
| | | 2a | 2b | 3 |
| | 1 | Amines | Amines | Treated |
| | Raw gas | to C1a | to C1b | gas |
| Temp. (° C.) | 37.6 | 47.6 | 47 | 48.3 |
| Pressure (Bar) | 76.2 | 75.9 | 73.8 | 73.8 |
| Volume flow | 75 000 | 320 | 45 | 63603 |
| rate (Sm3/h) | | | | |
| Mass flow rate | 68896.4 | 334566 | 47048 | 50295.3 |
| (kg/h) | | | | |
| Comp. (% mol) | | | | |
| CO2 | 9.6 | 0.0128 | 0.0128 | 1.6 |
| H2S | 6.0 | 0.01 | 0.01 | 0.0003 |
| COS | 0.0075 | — | — | 0.0001 |
| H2O | 0.12 | 88.7 | 88.7 | 0.1965 |
| MDEA | | 11.3 | 11.3 | |
| N2 | 0.23 | | | 0.2692 |
| C1 | 76.83 | | | 89.5463 |
| C2 | 4.235 | | | 4.9071 |
| C3+ | 2.977 | | | 3.48 |

Table 3 also shows the relevance of the method according to the invention in the instance of selective absorption of H₂S in relation to CO₂ in natural gas.

TABLE 3

| | Simulated method | |
|---|---|---|
| | according to document | Method according to the |
| | WO 96/19281 | invention |
| Stream number | 3 (treated gas) | 3 (treated gas) |
| Comp. (%) | | |
| CO₂ | 1.2 | 1.6 |
| H₂S | 2 | 4 |
| COS (ppm) | 1 | 1 |

Whereas the method according to WO-96/19,281 contains 1.2% CO₂ in the treated gas, the method according to the invention allows keeping 1.6% CO₂, which is close to the 2% CO₂ content sought in natural gas to be carried in a gas pipeline.

The economic considerations presented hereafter in Table 4 have been determined considering the cost of the main equipments (absorption column, regeneration column, heat exchangers, pump, reactor).

Table 4 gives the dimensions of the absorption column dimensioned according to the diagram of FIG. 2 provided in WO-96/19,281 and of column C1 according to the invention.

TABLE 4

| | Column 24-26 | Column C1 |
|---|---|---|
| | according to FIG. 2 of | according to |
| Criteria | WO 96/19281 | the invention |
| Height (m) | 28 | 28 |
| Diameter (m) upper section | 2400 | 2350 |
| Diameter (m) lower section | 2400 | 1400 |
| cost (M [symbol] ) | 2.47 | 1.9 |
| gain on cost (%) | | 23 |

The method according to the invention allows reduction of the cost of column C1 by 23%.

The method according to the invention also allows reduction of the energy consumption of pump P1 as shown in Table 5.

TABLE 5

| | Column according to | Column C1 according to |
|---|---|---|
| Criteria | document WO 96/19281 | the invention |
| Cost k [symbol] | 41 | 11 |
| Gain (%) | | 73 |
| Consumption (kW) | 32 | 4 |
| Gain (%) | | 87.5 |

### CONCLUSIONS

The method according to the invention allows achieving stringent specifications regarding COS content of the treated gas and to reduce the dimensions of the absorption column, which is the highest investment in the case of deacidifying natural gas. The gains obtained regarding the costs are significant. The method also allows improving the H₂S content selectivity in relation to CO₂ in the treated gas, in cases where an absorbent solution comprising a selective amine that selectively absorbs H₂S in relation to CO₂ is used. This advantage of the method according to the invention, is that unlike the prior art conventional methods of COS removal using a non-selective chemical or physical solvent which are ineffective to achieve stringent specifications, the invention has the capacity of selectively removing H₂S and COS in relation to CO₂, which cannot be obtained with conventional methods allowing COS removal.

1-11. (canceled)

12. A method of deacidizing a gas comprising H₂S and COS, comprising:
a) contacting the gas with a first absorbent solution stream in a first absorption section to obtain an H₂S-depleted gaseous effluent and an H₂S-laden absorbent solution;
(b) feeding the H₂S-depleted gaseous effluent into a reactor comprising a solid catalyst that performs a reaction of hydrolysis of the COS to H₂S and CO₂ to obtain a COS-depleted gaseous effluent;
(c) contacting the COS-depleted gaseous effluent with a second absorbent solution stream in a second absorption section to obtain a treated gas and an absorbent solution partly laden with H₂S; and
(d) regenerating the H₂S-laden absorbent solution to obtain a regenerated absorbent solution stream; and wherein
in (a), the first absorbent solution stream comprises a first portion of the regenerated absorbent solution obtained in (d), as well as an absorbent solution partly laden with H₂S, and in (c) a second absorbent solution stream comprises a second portion of the regenerated absorbent solution stream obtained in (d).

13. A method as claimed in claim 12, wherein the first portion comprises at least 70 vol. % of the regenerated absorbent solution stream obtained in (d) and the second portion comprises less than 30 vol. % of the regenerated absorbent solution stream obtained in (d).

14. A method as claimed in claim 12, wherein the pressure in the first absorption section is at least 2 bars above pressure in the second absorption section and wherein the pressure is raised by pumping the absorbent solution partly laden with H₂S prior to feeding the absorbent solution into the first absorption section.

15. A method as claimed in claim 13, wherein the pressure in the first absorption section is at least 2 bars above pressure in the second absorption section and wherein the pressure is raised by pumping the absorbent solution partly laden with H₂S prior to feeding the absorbent solution into the first absorption section.

16. A method as claimed in claim 12, wherein reactor comprises a COS hydrolysis reaction catalyst.

17. A method as claimed in claim 13, wherein reactor comprises a COS hydrolysis reaction catalyst.

18. A method as claimed in claim 14, wherein reactor comprises a COS hydrolysis reaction catalyst.

19. A method as claimed in claim 15, wherein reactor comprises a COS hydrolysis reaction catalyst.

20. A method as claimed in claim 16, wherein the catalyst is selected from among a titanium oxide and alumina oxide.

21. A method as claimed in claim 17, wherein the catalyst is selected from among a titanium oxide and alumina oxide.

22. A method as claimed in claim 18, wherein the catalyst is selected from among a titanium oxide and alumina oxide.

23. A method as claimed in claim 12, wherein the regenerated absorbent solution stream comprises at least one amine in an aqueous phase.

24. A method as claimed in claim 13, wherein the regenerated absorbent solution stream comprises at least one amine in an aqueous phase.

25. A method as claimed in claim 14, wherein the regenerated absorbent solution stream comprises at least one amine in an aqueous phase.

26. A method as claimed in claim 15, wherein the regenerated absorbent solution stream comprises at least one amine in an aqueous phase.

27. A method as claimed in claim 16, wherein the regenerated absorbent solution stream comprises at least one amine in an aqueous phase.

28. A method as claimed in claim 17, wherein the regenerated absorbent solution stream comprises at least one amine in an aqueous phase.

29. A method as claimed in claim 18, wherein the regenerated absorbent solution stream comprises at least one amine in an aqueous phase.

30. A method as claimed in claim 19, wherein the regenerated absorbent solution stream comprises at least one amine in an aqueous phase.

31. A method as claimed in claim 20, wherein the regenerated absorbent solution stream comprises at least one amine in an aqueous phase.

32. A method as claimed in claim 21, wherein the regenerated absorbent solution stream comprises at least one amine in an aqueous phase.

33. A method as claimed in claim 22, wherein the regenerated absorbent solution stream comprises at least one amine in an aqueous phase.

34. A method as claimed in claim 12 wherein, in (d), at least one distillation of the H₂S-laden absorbent solution is carried out.

35. A method as claimed in claim 13 wherein, in (d), at least one distillation of the H₂S-laden absorbent solution is carried out.

36. A method as claimed in claim 14 wherein, in (d), at least one distillation of the H₂S-laden absorbent solution is carried out.

37. A method as claimed in claim 16 wherein, in (d), at least one distillation of the H₂S-laden absorbent solution is carried out.

38. A method as claimed in claim 19 wherein, in (d), at least one distillation of the H₂S-laden absorbent solution is carried out.

39. A method as claimed in claim 23 wherein, in (d), expansion of the H₂S-laden absorbent solution is also carried out.

40. A method as claimed in claim 34 wherein, in (d), expansion of the H₂S-laden absorbent solution is also carried out.

41. A method as claimed in claim 12, wherein the absorbent solution comprises a solvent allowing selective removal of H₂S in relation to CO₂.

42. A method as claimed in claim 13, wherein the absorbent solution comprises a solvent allowing selective removal of H₂S in relation to CO₂.

43. A method as claimed in claim 14, wherein the absorbent solution comprises a solvent allowing selective removal of H₂S in relation to CO₂.

44. A method as claimed in claim 16, wherein the absorbent solution comprises a solvent allowing selective removal of H₂S in relation to CO₂.

45. A method as claimed in claim 27, wherein the absorbent solution comprises a solvent allowing selective removal of H₂S in relation to CO₂.

46. A method as claimed in claim 34, wherein the absorbent solution comprises a solvent allowing selective removal of H₂S in relation to CO₂.

47. A method as claimed in claim 37, wherein the absorbent solution comprises a solvent allowing selective removal of H₂S in relation to CO₂.

48. A method as claimed in claim 41, wherein the absorbent solution comprises a tertiary amine whose rate of reaction with H₂S is at least twice as high as its rate of reaction with CO₂.

49. A method as claimed in claim 12, wherein the gas is selected from among a natural gas, a synthesis gas and a combustion fume.
